(19) United States
(12) Patent Application Publication
(10) Pub. No.: US 2005/0206380 A1
(43) Pub. Date: Sep. 22, 2005

(54) Method and apparatus for temperature-controlled application of radio frequency power in magnetic resonance imaging

(76) Inventor: Derek A. Seeber, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 10/805,152

(22) Filed: Mar. 19, 2004

(51) Int. Cl. G01V 3/00

(52) U.S. Cl. 324/315; 324/318; 324/309

(57) ABSTRACT

Temperature sensitive MRI measurements are used to monitor the effect of radio signals including the NMR signals themselves. In one embodiment, a closed loop MRI system maximizes acquisition speed without exceeding safety thresholds of tissue temperature by monitoring the tissue temperature using NMR signals in real-time.

### CROSS-REFERENCE TO RELATED APPLICATIONS

--

### STATEMENT REGARDING FEDERALLY SPONSORED RESEARCH OR DEVELOPMENT

--

### BACKGROUND OF THE INVENTION

The field of the invention is magnetic resonance imaging (MRI) and in particular, MRI systems with high magnetic field strengths where tissue heating may limit the application of radio frequency power.

In MRI, a uniform magnetic field B₀ is applied to an imaged object along the z-axis of a Cartesian coordinate system fixed with respect to the imaged object. The effect of the magnetic field B₀ is to align the object's nuclear spins along the z-axis.

In response to a radio frequency (RF) excitation signal of the proper frequency oriented within the x-y plane, the nuclei precess about the z-axis at their Larmor frequencies according to the following equation:
ω=γB₀ (1)

where ω is the Larmor frequency and γ is the gyromagnetic ratio which is a constant and a property of the particular nuclei. The value of the gyromagnetic ratio γ for protons is 42.5759 MHz/Tesla.

In a typical imaging sequence for an axial slice, an RF excitation signal having a frequency centered at the Larmor frequency of the protons is applied to the imaged object at the same time as a magnetic field gradient G_{z} is applied. The gradient field G_{z} causes only the nuclei in a slice with a limited width through the object along an x-y plane to be excited into resonance.

After the excitation of the nuclei in this slice, magnetic field gradients are applied along the x-and y-axes. The gradient along the x-axis, Gₓ, causes the nuclei to precess at different frequencies depending on their position along the x-axis, that is, Gₓ spatially encodes the precessing nuclei by frequency. The y-axis gradient, G_{y}, is incremented through a series of values and encodes the y position into the rate of change of phase of the precessing nuclei as a function of gradient amplitude, a process typically referred to as phase encoding.

A weak nuclear magnetic resonance generated by the precessing nuclei may be sensed by the RF coil and recorded as an NMR signal. From this NMR signal for a series of such signal acquisitions with different phase encodings, a slice image may be derived according to well-known reconstruction techniques. An overview of NMR image reconstruction is contained in the book “Magnetic Resonance Imaging, Principles and Applications” by D. N. Kean and M. A. Smith.

New MRI machines are being developed with higher magnetic fields B₀. Higher magnetic field strengths may significantly decrease the amount of time required to obtain the scan data and provide higher signal-to-noise ratio signals allowing the production of higher resolution images. High field strengths also provide more pronounced chemical shift and may improve imaging techniques relying on this property and allow new spectroscopic-type MRI imaging applications.

The amount of RF energy deposited in tissue is roughly proportional to the square of the strength of the polarizing magnetic field B₀, and accordingly, high field MRI systems may create significant tissue heating. The FDA enforces limits on the heating of body tissue by RF energy, requiring tissue to remain cooler than 41° C. and further restricting RF wattage per kilogram for specific body areas such as the torso or brain. Currently, excess tissue heating is avoided by limiting the repetition rate of the RF excitation signals according to a mathematical model of the tissue being imaged. Such models can be quite sophisticated, but at the expense of often requiring extensive computational equipment or computational time.

The full benefit of high field systems may be lost if the RF exposure of the patient is unnecessarily limited.

### SUMMARY OF THE INVENTION

The present invention recognizes that improved control of RF power deposition to tissue can be obtained using real-time measurements of tissue temperature within the patient, and further that these real time measurements may be made using the NMR signals collected by the MRI machine. Real-time temperature measurement of tissue allows closed loop control of RF energy to increase the performance of the MRI machine. The same technique may be used to provide improved modeling of tissue under exposure to RF energy.

Specifically, the present invention provides a method of operating a high field MRI system comprising the steps of acquiring NMR signals from a patient extracting tissue temperature data from at least some of the NMR signals and extracting tissue image data from at least some of the NMR signals for the production of an MRI image. These steps are repeated while the tissue temperature measurements are below a safety threshold.

Thus, it is one object of the invention to provide a real-time monitoring of tissue temperature to better realize the high scan rates possible in high field MRI systems.

The rate of RF stimulation may be changed as a function of tissue temperature.

Thus, it is an object of the invention to provide a continuously varying feedback response to increasing tissue temperature.

The method may include the step of halting only the acquisition of NMR data for the extraction of tissue image data when the tissue temperature measurements are above a safety threshold (below the temperature limit for the tissue) and continuing the acquisition of the NMR data for the extraction of tissue temperature.

Thus, it is another object of the invention to provide for a monitoring of tissue temperature without other deposition of RF energy to promote tissue cooling without loss of temperature data indicating when the tissue is sufficiently cool.

The method may include the step of halting the acquisition of NMR data for a predetermined cooling period when the tissue temperature measurements are above the safety threshold.

Thus it is another object of the invention to provide for a simple method of controlling RF tissue heating that maximizes cooling by eliminating the need for NMR based temperature monitoring.

The acquisitions of NMR data for temperature measurement and NMR data for imaging may be different pulse sequences.

Thus, it is another object of the invention to provide for optimal NMR sequences for these different purposes.

The method may include the step of extracting baseline tissue temperature from the NMR signals at a time of known patient temperature and using this baseline temperature to compute tissue temperature.

Thus, it is another object of the invention to provide the ability to use NMR techniques that measure relative temperature shifts rather than absolute temperature.

The time of known patient temperature may be at the beginning of the NMR signals and the known temperature may be a measured body temperature of the patient.

Thus it is another object of the invention to provide for flexible methods of establishing an initial temperature of the patient either as the patient's normal body temperature or measured temperature of the patient by auxiliary means such as clinical thermometers or the like.

The method of extracting tissue temperature from the NMR signal may monitor temperature dependent phase shift of the NMR signal or may detect saturation of spins by a narrow band saturating RF waveform, at the resonant frequency of protons, at temperatures at the safety threshold.

Thus, the invention is adaptable to a variety of techniques of measuring temperature.

The present invention contemplates implementation of the invention wholly in a standard MRI machine or with the use of a local coil having an antenna array coupling to a region of interest in a patient, a conductor for connecting the antenna array to signal processing circuitry of an MRI machine and a local oscillator having the ability to produce a narrow band radio frequency signal saturating tissue protons only when the tissue has reached a safety temperature limit.

Thus, it is another object of the invention to provide an add-on component for MRI machines that may provide a precise oscillator for the measurement of absolute tissue temperature.

Generally, the present invention also contemplates the creation of a computer program that may operate on an MRI machine and/or a method using the computer program for modeling the thermodynamic qualities of tissue comprising the steps of: exposing the tissue to RF energy at least in part incident to the acquisition of the NMR signals from the patient, extracting tissue temperature from the NMR signals, and modeling the tissue based on the temperature change of the tissue as a function of deposited RF energy. These models may be used for establishing maximum RF deposition for use with the prior art, cooling periods per the present invention, or to generally investigate the heating effects of RF energy by cell phones and other radio appliances.

These particular objects and advantages may apply to only some embodiments falling within the claims and thus do not define the scope of the invention.

### BRIEF DESCRIPTION OF THE FIGURES

FIG. 1 is a simplified, side elevational view of a local coil for use in head imaging having an associated narrow band oscillator for saturation of selective proton spins;

FIG. 2 is a power spectrum plot of tissue protons in the absence of gradient fields at a first and second temperature showing the chemical shift of their resonant frequencies with heating together with a plot of a power spectrum of the oscillator of FIG. 1 such as may saturate protons of a given frequency showing the suppression of these frequencies in the shifted power spectrum of tissue protons;

FIG. 3 is a representation of two successive MRI images obtained with the local coil of FIG. 1 showing changes in regions of saturation such as indicate tissue at a safety threshold;

FIG. 4 is a figure similar to FIG. 3 showing two successive phase MRI images positioned above a cross-section of values of both images (when aligned) along line 4--4 showing an alternative method of calculating tissue temperature also suitable for use with the present invention;

FIG. 5 is a flow chart showing the principal steps of the present invention in managing RF energy deposition such as may be implemented in computer software; and

FIG. 6 is a flow chart of an alternative method of using the present invention for the modeling of tissue under RF heating.

### DETAILED DESCRIPTION OF THE PREFERRED EMBODIMENT

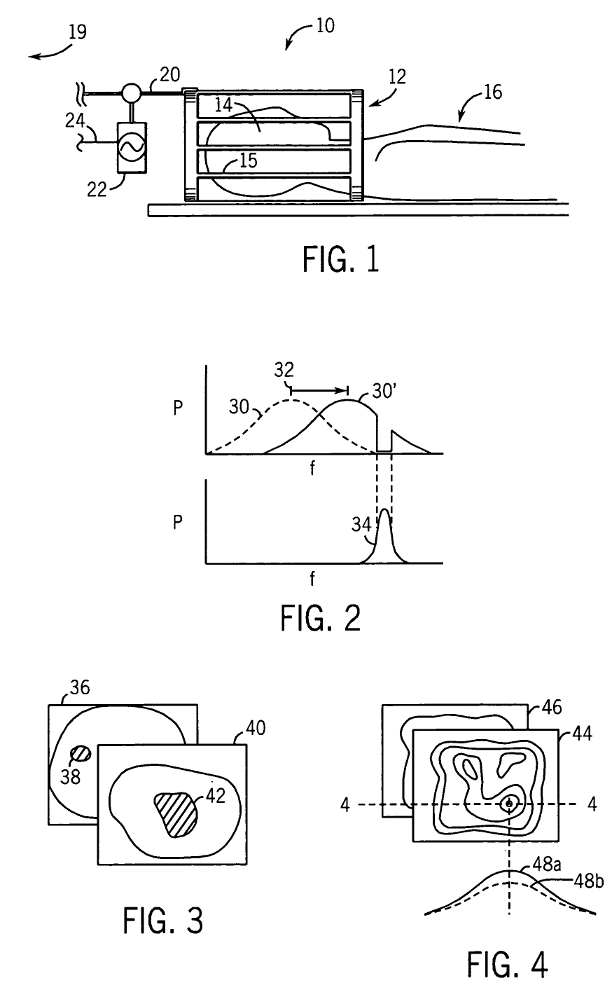

Referring now to FIG. 1, a local coil 10, for example a head coil, may provide a volume 12 into which the head 14 of a patient 16 may be placed for MRI scanning. The present invention is not limited to local coils or to head coils, but this coil is shown by way of example. The volume 12 is defined generally by antenna conductors 15 that serve to transmit radiofrequency excitation signals to the patient's head 14 and/or to receive NMR signals from the patient's head 14 as is understood in the art.

A cable 20 connects the antenna conductors 15 of the local coil 10 to an MRI machine 19 (not shown) to receive the radiofrequency excitation signals from the MRI machine 19 and to transmit the received NMR signals to the MRI machine 19.

The local coil 10 may include a spin saturation oscillator 22 providing a narrow band RF signal (approximately ten Hertz) that is conducted through cable 20 to the antenna conductors 15 such as may saturate heated protons in patient tissue as will be described below. The spin saturation oscillator 22 may include a control line 24 received by the MRI machine 19 to allow the spin saturation oscillator 22 to be turned on and off as may be appropriate.

Referring also now to FIG. 2, when excited into resonance, protons of water filled tissue will exhibit a power spectrum 30 having a center frequency 32. Heating of this tissue will cause a shift in the power spectrum to power spectrum 30′ at about one Hertz per degree of centigrade of heating. A power spectrum 34 of the spin saturation oscillator 22 is set to be largely outside of the range of power spectrum 30, but to overlap slightly with the upper frequency range of the power spectrum 30′. In this way, the spin saturation oscillator 22 will saturate those protons that have been heated, for example by RF energy, to a predetermined temperature. The center frequency of the power spectrum 34 of the spin saturation oscillator 22 is thus set to a frequency of natural resonance of water protons in tissue that is at a safety threshold temperature being a desired limit below which tissue is assured of not having thermal damage. At normal tissue temperatures, the effect of the spin saturation oscillator 22 will be minimal or nonexistent, but as the tissue heats, certain of the water protons contributing to the image will be saturated.

Referring now generally to FIG. 3, a baseline image 36 may be acquired using the MRI machine 19 and conventional imaging sequences. This baseline image 36 will have some areas 38 of low or minimal signal strength (for example, caused by a lack of protons) and that is thus indistinguishable from areas having saturation of their protons. This baseline image 36 is stored and compared to a later acquired image 40 during a period when tissue heating is to be monitored. This later acquired image 40 will have an enlarged area 42 of low signal strength encompassing both regions of proton deficiency and regions where the protons are saturated by the spin saturation oscillator 22. A comparison of images 36 and 42 will thus provide an indication of the saturated tissue caused by the spin saturation oscillator 22 and may be used to determine that certain tissue has been heated to a point at which it is about to cross a safety threshold temperature. This measurement may be used as will be described below to moderate the application of further radiofrequency power. The measurement obtained by FIG. 3 is one of absolute temperature of the tissue so measured.

Generally, the spin saturation oscillator 22 will be gated to provide saturation only when the gradient fields are not applied. This gating may be controlled by the MRI machine 19 or by detection of the RF excitation pattern at the local coil 10.

Alternatively as shown in FIG. 4, a phase image 44 may be produced showing the phase of the proton spins at various points within the tissue. Phase images differ from typical diagnostic MRI images by indicating the phase rather than the amplitude of proton spins at different voxels of the patient. Ideally, the phase image is created through a gradient echo pulse sequence which does not obscure phase differences caused by temperature dependent frequency shifting in the proton spins.

As before, a baseline phase image 46 may also be obtained and a difference in phase value 48a for the current image versus the corresponding phase value 48b for the baseline image may be used to obtain an indication of temperature shift. Phase value “rollover” caused by the periodicity of angular measurement at 360 degrees may be accommodated by frequent phase measurements that track phase shift evolution with time eliminating any ambiguity.

In contrast to the spin saturation measurement of FIG. 3, the phase shift indicates only a difference in temperature and thus the initial temperature at the time of the baseline phase image 46 must be known accurately. This may be assumed to be normal body temperature or a clinical measurement of the patient temperature may be taken.

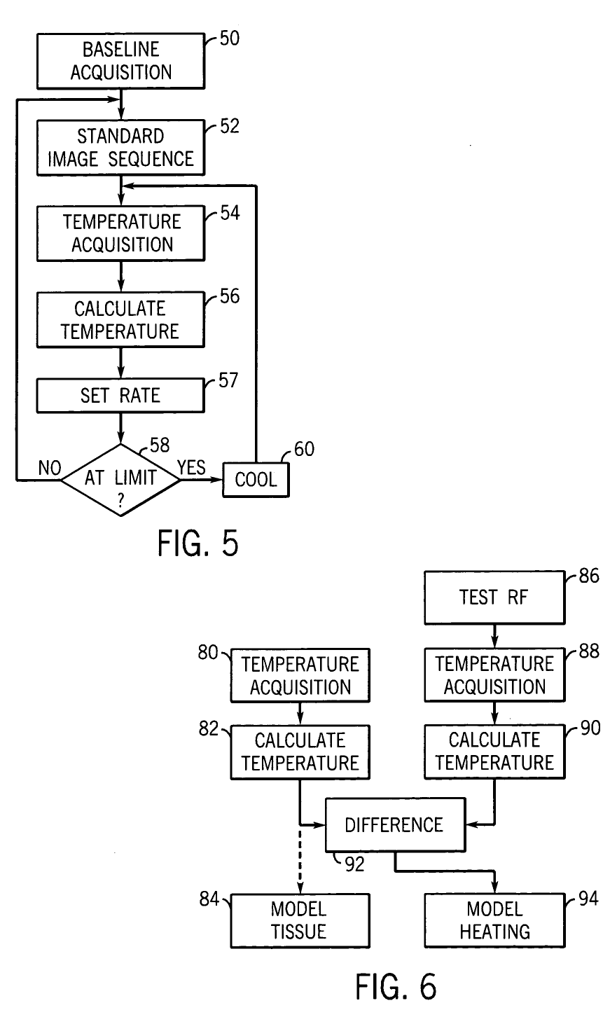

Referring now to FIG. 5 in general, either or both of these techniques may be used to control RF energy deposition in imaged patient tissues. These steps may be implemented by software running in the MRI machine 19 or by a combination of software and manual action.

As indicated by process block 50, initially, a baseline measurement will be made to produce either of baseline images 36 or 46. Preferably as indicated by process block 52, the baseline acquisition of process block 50 is followed by all or a portion of a standard imaging sequence. The portion of the standard imaging sequence is selected to ensure that excess tissue heating will not occur for this initial acquisition.

Generally, two separate sequences will be used for process blocks 50 and 52, each sequence optimized for its particular purpose of temperature measurement or imaging. However, a single acquisition may allow both imaging and temperature measurement and the present invention is applicable to both approaches.

At process block 54, another temperature acquisition is made to acquire either a saturation image 42 or a phase image 44.

At process block 56 the images acquired in process blocks 50 and 54 are compared to determine the temperature of the patient tissue at multiple points in the imaged volume. An effective tissue temperature value is then obtained being, for example, the highest temperature of a threshold number of voxels in the image, but possibly including algorithms that discount isolated heating of individual voxels that would be expected to quickly cool or be the result of measurement noise.

The effective tissue temperature is then compared to a desired maximum tissue temperature (a particular safety threshold) based on knowledge about tissue heat tolerance. An optional block 57, the frequency at which acquisitions of 52 and 54 are obtained is controlled as a function of the comparison of tissue temperature to the desired maximum tissue temperature. This step slows the acquisition rate down as the temperature rises to the safety threshold providing a smooth control of heating in a closed loop control strategy. The intent of this control strategy is to prevent the temperature from swinging widely in heating and cooling cycles.

At decision block 58, the calculated temperature of the tissue is compared to an absolute safety threshold typically somewhat higher than the safety threshold used in process block 57, but still below a point of irreversible tissue damage. If the temperature of the tissue or critical mass of the tissue is below the absolute safety threshold, then the program loops back to the top of process block 52 to repeat the image process.

If the absolute safety threshold has been exceeded at process block 58, the program proceeds to process block 60 for a cool down period. This cool down period may be simply a fixed amount based on a coarse modeling of the tissue with respect to its ability to dissipate heat or maybe a fixed multiple of the previously set repetition rate of the NMR acquisitions. As will be described, the model may be refined using a variation of the invention as described below.

At the conclusion of this cool down period the program may proceed directly to process block 52 to begin imaging again, or in a preferred embodiment, may proceed to process block 54 to obtain a temperature acquisition only, skipping the standard image sequence of process block 52 until cooling of the tissue has been assured through measurement.

Referring now to FIG. 6, the present invention also provides a generalized technique for modeling a tissue's ability to accommodate RF heating. In a simple modeling example, an NMR temperature acquisition may be taken as indicated by process block 80 where the acquisition deposits a known amount of radio frequency energy on the patient and may include one or more images being acquired, for example, a baseline and later comparison image as described above.

At process block 82, the temperature rise in the tissue may be determined and at process block 84, a model of the tissue may be developed generally relating the known RF field to measure temperature rise in the tissue over time. This process may be repeated for different amounts of RF deposition to obtain additional data points for the model.

This model may be used to more accurately generate procedures for standard MRI machines that do not implement the present invention, or may be used to model the cooling described above, and may be performed for different sites on the patient so as to provide different models, for example, for the patient's head as opposed to a patient's knee or torso.

A simplified temperature acquisition, as described, may establish a baseline against which temperature effects of other radio frequency equipment, for example cell phones, may be tested as indicated by process block 86. In this case, the patient or a phantom may be exposed to an external radio frequency source and then followed by an NMR temperature acquisition as indicated by process block 88 similar to that of process block 80.

As has been described above, this NMR temperature acquisition may be used to determine temperature of the tissue as indicated by process block 90. At process block 92, the difference between the temperature without the RF test exposure and the temperature with the RF text exposure may be compared and at process block 94 used to measure or model the effect of the test radio frequency signal on the tissue or phantom.

It is specifically intended that the present invention not be limited to the embodiments and illustrations contained herein, but include modified forms of those embodiments including portions of the embodiments and combinations of elements of different embodiments as come within the scope of the following claims.

1. A method of operating a high field MRI system comprising the steps of:
(a) acquiring NMR signals from a patient;
(b) extracting tissue temperature data from at least some of the NMR signals;
(c) extracting tissue image data from at least some of the NMR signals for the production of an MRI image; and
(d) repeating steps (a)-(c) while the tissue temperature measurements are below a safety threshold.

2. The method of claim 1 further including the step of changing the rate of acquiring the NMR signals as a function of tissue temperature.

3. The method of claim 1 including the step of halting only the acquisition of NMR data for the extraction of tissue image data when the tissue temperature measurements are above the safety threshold and not the NMR data for the extraction of tissue temperature data.

4. The method of claim 1 including the step halting the acquisition of NMR data for a predetermined cooling period when the tissue temperature measurements are above the safety threshold.

5. The method of claim 3 wherein the predetermined cooling period is determined from a mathematical model of tissue cooling.

6. The method of claim 1 wherein step (b) and step (c) extract data from NMR signals obtained in different acquisitions.

7. The method of claim 1 including the step of extracting baseline tissue temperature data from the NMR signals at a time of known patient temperature and wherein the step of extracting tissue temperature data from the NMR signals employs the baseline tissue temperature.

8. The method of claim 7 wherein the time of known patient temperature is at the beginning of acquiring NMR signals from the patient.

9. The method of claim 7 wherein the known patient temperature is a measured body temperature of the patient.

10. The method of claim 1 wherein the extracting tissue temperature data from the NMR signals monitors temperature dependent phase shift of the NMR signals.

11. The method of claim 1 wherein the extracting tissue temperature data from the NMR signals detects saturation of spins by a narrow band saturating RF waveforms at a resonant frequency of protons at temperatures at the safety threshold.

12. A high field MRI system comprising:
a polarizing magnet sized to receive at least a portion of a patient;
RF transceiver electronics for stimulating the patient tissue in the polarizing magnetic field to acquire NMR signals from a patient;
image processing electronics operating to:
(i) extracting tissue temperature data from at least some of the NMR signals;
(ii) extracting tissue image data from at least some of the NMR signals for the production of an MRI image; and
(iii) repeating collection of NMR signals for the production of an MRI image only while the tissue temperature measurements are below a safety threshold.

13. The high-field MRI system of claim 12 wherein the image processing electronics further changes the frequency of acquiring NMR signals as a function of tissue temperature.

14. The high-field MRI system of claim 12 wherein the image processing electronics further halts only the acquisition of NMR data for the extraction of tissue image data when the tissue temperature measurements are above the safety threshold and not the NMR data for the extraction of tissue temperature data.

15. The high-field MRI system of claim 12 wherein the image processing electronics further determines the predetermined cooling period from a mathematical model of tissue cooling.

16. The high-field MRI system of claim 12 wherein the image processing electronics extracts tissue temperature and tissue image data from different NMR signals obtained in different acquisitions.

17. The high-field MRI system of claim 12 wherein the image processing electronics further operates to extract baseline tissue temperature data from the NMR signals at a time of known patient temperature and wherein the extraction of temperature data from the NMR signals employs the baseline tissue temperature.

18. The high-field MRI system of claim 12 wherein the time of known patient temperature is at the beginning of acquiring NMR signals from the patient.

19. The high-field MRI system of claim 12 wherein the known patient temperature is a measured body temperature of the patient.

20. The high-field MRI system of claim 12 wherein the image processing electronics extracts temperature data from the NMR signals by monitoring temperature dependent phase shift of the NMR signals.

21. The high-field MRI system of claim 12 wherein the image processing electronics extracts tissue temperature data from the NMR signals detects saturation of spins by a narrow band saturating RF waveform at a resonant frequency of protons at temperatures at the safety threshold.

23. A local coil comprising:
an antenna array coupling to a region of interest in a patient;
a conductor for connecting the antenna array to signal processing circuitry of an MRI machine; and
a local oscillator producing a narrow band radiofrequency signal saturating tissue protons only when the tissue has reached a safety temperature limit.

24. The local coil of claim 23 wherein the local oscillator includes a signal lead communicating with the MRI machine to turn the local oscillator on and off.

25. A computer program for execution on a MRI machine comprising the program steps of:
(a) acquiring NMR signals from a patient;
(b) extracting tissue temperature data from at least some of the NMR signals;
(c) extracting tissue image data from at least some of the NMR signals for the production of an MRI image; and
(d) repeating steps (a)-(c) while the tissue temperature measurements are below a safety threshold.

26. The computer program of claim 25 including the program step of halting the acquisition of only NMR data for the production of an MRI image and not NMR data for the production of tissue temperature when the tissue temperature measurements are above the safety threshold.

27. The computer program of claim 25 including the program step of halting the acquisition of NMR data for a predetermined cooling period when the tissue temperature measurements are above the safety threshold.

28. A method of modeling the thermodynamic qualities of tissue comprising the steps of:
(a) exposing the tissue to RF energy at least in part incident to the acquisition of NMR signals from a patient;
(b) extracting tissue temperature data from the NMR signals; and
(c) modeling the tissue based on the temperature change of the tissue as a function of deposited RF energy.
